(19) United States
(12) Patent Application Publication
(10) Pub. No.: US 2006/0114949 A1
(43) Pub. Date: Jun. 1, 2006

(54) Ultra-compact, low cost high powered laser system

(76) Inventor: Jeffrey E. Ungar, Valley Village, CA (US)

Correspondence Address: IRELL & MANELLA LLP, 840 NEWPORT CENTER DRIVE, SUITE 400, NEWPORT BEACH, CA, 92660, US

(21) Appl. No.: 11/248,769

(22) Filed: Oct. 11, 2005

Related U.S. Application Data
(63) Continuation-in-part of application No. 11/006,975, filed on Dec. 7, 2004.
Application No. 11/006,975 is a continuation-in-part of application No. 10/417,920, filed on Apr. 16, 2003, now abandoned.
(60) Provisional application No. 60/374,913, filed on Apr. 22, 2002.

(51) Int. Cl. H01S 3/10; H01S 3/08

(52) U.S. Cl. 372/25; 372/102

(57) ABSTRACT

A laser system that has an optical fiber and a laser diode coupled to an optical combiner. The optical fiber includes a chirped grating. The laser diode generates a laser pulse. Because of various internal effects the rear portion of the laser pulse contains light with longer wavelengths than light at the front end of the pulse. The laser pulse travels through the combiner and into the chirped grating. The chirped grating has a spacing that decreases from a proximal end to a distal end of the grating. The longer wavelengths of the laser pulse reflect from the proximal end of the grating. The shorter wavelengths reflect from the distal end of the grating and combine with the longer wavelengths in the combiner. The greater distance spatially shifts the shorter wavelengths back into the longer wavelengths. The optical fiber has a length between 0.1 and 2 kilometers to store optical energy and produce a high powered laser pulse.

### REFERENCE TO CROSS RELATED APPLICATION

This application is a continuation-in-part of application Ser. No. 11/006,975, filed on Dec. 7, 2004, which is a continuation-in-part of application Ser. No. 10/417,920 filed on Apr. 16, 2003, abandoned, which claims priority under 35 U.S.C §119(e) to provisional Application No. 60/374,913 filed on Apr. 22, 2002.

### BACKGROUND OF THE INVENTION

1. Field of the Invention

The subject matter disclosed generally relates to the field of laser diodes.

2. Background Information

Lasers have a variety of applications in fields such as medicine, communications and in military systems. Some applications require a very high powered laser. For example, laser radar (LADAR) requires a very high powered pulsed laser to generate light beams that can travel long distances in free space. A laser for a LADAR system should be rugged, compact, lightweight, inexpensive, easily modulated and have a high power efficiency. Conventional laser such as Er:YAG and Nd:YAG lasers are relatively large, energy inefficient and are difficult to modulate.

Laser diodes are ideal for LADAR application. Unfortunately, most laser diodes only generate output beams under one watt, significantly below what is needed for a LADAR application. The power output can be increased by combining a number of laser diodes in parallel. To date multi-diode applications do not provide a high quality beam. It would be desirable to provide a high powered pulsed laser system that utilizes a laser diode and generates a high quality beam.

U.S. Pat. No. 5,982,963 issued to Feng et al. and U.S. Application No. 2001/0036332 published under Brennan III et al. disclose systems with an optical circulator in combination with a grating that together chirp a pulse of light emitted by a laser source. Although Feng and Brennan can vary the width of a laser pulse, these referenced systems do not effectively increase the output into a high power beam.

### BRIEF SUMMARY OF THE INVENTION

A laser system that includes an optical combiner coupled to a laser diode. The optical combiner is also coupled to an optical fiber that includes a grating and accumulates optical energy. The optical fiber has a length between 0.1 and 2 kilometers to produce a high powered laser pulse.

### BRIEF DESCRIPTION OF THE DRAWINGS

FIG. 1 is a schematic of an embodiment of a laser system of the present invention;

FIG. 2 is an illustration of a chirped grating of the laser system;

FIG. 3 is an illustration showing a comparison of an output beam of the system versus the output beam of laser diode.

### DETAILED DESCRIPTION

Disclosed is a laser system that has an optical fiber and a laser diode coupled to an optical combiner. The optical fiber includes a chirped grating. The laser diode generates a laser pulse in response to an electrical pulse from a driver circuit. Because of various internal effects the rear portion of the laser pulse contains light with longer wavelengths than light at the front end of the pulse. The laser pulse travels through the combiner and into the chirped grating.

The chirped grating has a spacing that decreases from a proximal end to a distal end of the grating. The longer wavelengths of the laser pulse reflect from the proximal end of the grating. The shorter wavelengths reflect from the distal end of the grating and combine with the longer wavelengths in the combiner. The shorter wavelengths, which were at the front of the pulse, have to travel a greater distance than the longer wavelengths. The greater distance spatially shifts the shorter wavelengths back into the longer wavelengths. The optical fiber has a length between 0.1 and 2 kilometers that allows the fiber to store optical energy and function as an optical accumulator. The result is a laser diode system that produces a high powered laser pulse.

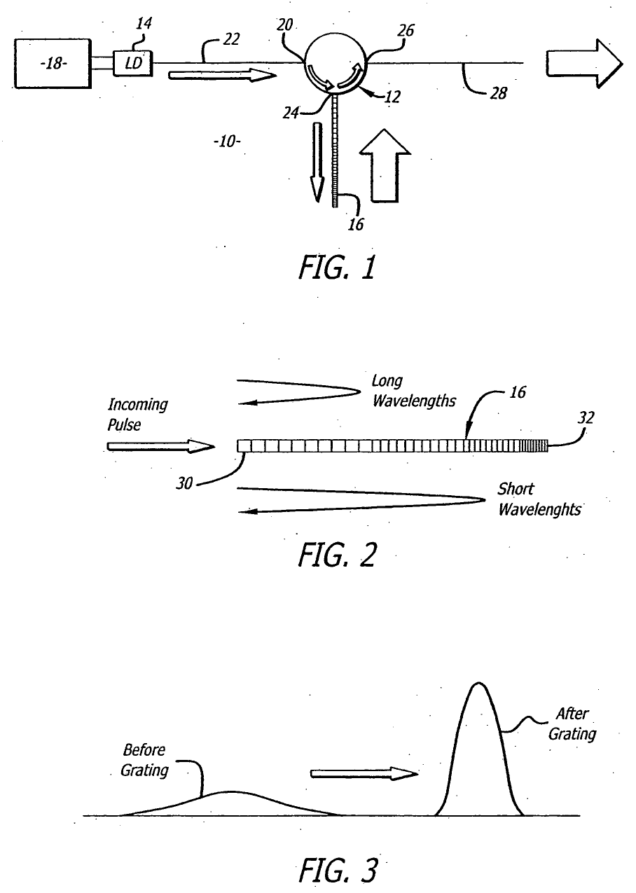

Referring to the drawings more particularly by reference numbers, FIG. 1 shows an example of an embodiment of a laser system 10. The system 10 includes an optical combiner 12 that is coupled to a laser diode 14 and an optical fiber 16. The optical fiber 16 contains a chirped Bragg grating. The optical combiner 12 may be an optical circulator. The combiner 12 and grated fiber 16 together compress and amplify a light pulse emitted by the laser diode 14.

The laser diode 14 receives an electrical pulse from a control and driver circuit 18. The electrical pulse induces stimulated light emission in the laser diode 14. The electrical pulse generates a corresponding pulse of light that is emitted from the diode 14. Because of thermal and electrical carrier effects in the laser diode 14 the light pulse will have an optical wavelength that changes during the pulse. The leading portion of the light pulse may, for example, have shorter wavelengths than the trailing portion of the pulse. The laser diode 14 may be designed so as to optimize the spread in wavelengths between the leading and trailing edges of the pulse.

The light pulse is guided to a first port 20 of the optical combiner 12 by an optical fiber 22. The light enters the grated fiber 16 through a second port 24 of the optical combiner 12. The final compressed light pulse exits a third port 26 of the combiner 12 to another optical fiber 28. Although optical fibers 22 and 28 are shown and described, it is to be understood that the fibers are not required. For example, the light pulse may enter and exit the optical combiner 12 in free space.

As shown in FIG. 2 the grating of the optical fiber 16 may be chirped so that the spacing varies across the length of the grating from a proximal end 30 to a distal end 32. The spacing decreases from the proximal end 30 to the distal end 32 of the grating. The spacing is wider at the proximal end 30 of the grating so that the longer wavelengths of light in the trailing portion of the light pulse quickly reflect back into the combiner 12. The shorter wavelengths of light travel farther down the optical fiber 16 before being reflected back to the optical combiner 12. The grating spatially phase shifts portions of the light pulse so that the resultant pulse is compressed.

FIG. 3 shows the compression of the light pulse. The output of the laser diode is spread out as shown in the pulse at the left hand portion of FIG. 3. The grating of the optical fiber 16 phase shifts the shorter wavelengths of light so that the pulse is compressed as shown at the right hand portion of FIG. 3. Compressing the light pulse also increases the peak amplitude of the pulse.

Bragg gratings with varying spacing are commercially available and are typically used in fiber optic communication systems to compensate for chromatic dispersion. The spacing and length of the grating will depend upon the wavelengths of the light pulse generated by the laser diode 14.

The optical fiber 16 has a length so that the fiber 16 stores optical energy. The optical fiber has a length between 0.1 to 2 kilometers. The accumulator function of the fiber increases the power of the output laser pulse. The stored energy is a function of the fiber length in accordance with the following equation:

$$E = \frac{2 \cdot P \cdot L \cdot N}{c} \qquad ( 1 )$$

where;
E=the energy stored by the fiber.
P=the power output of the laser diode.
L=the length of the fiber.
n=the index of refraction of the fiber.
c=the speed of light.

By way of example, if the index n is 1.5 and the diode output power is 2 W, the stored energy would be 20 microJoules for a fiber length of 1 kilometer. In a system with this index and output power, a fiber range of 0.1 to 2 km would store energy between 500 nanoJoules and 100 microJoules, respectively.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art. Although a laser diode with shorter wavelength at the front of the pulse is described, it is to be understood that the laser diode may be constructed to have longer wavelength at the front of the pulse. With such a construction the chirped grating would have a spacing that increased from the proximal end to the distal end.

What is claimed is:

1. A laser system, comprising:
a laser diode;
an optical fiber that contains a grating and has a length between 0.1 and 2 kilometers to accumulate optical energy; and,
an optical combiner coupled to said laser diode and said optical fiber.

2. The laser system of claim 1, wherein said optical combiner is an optical circulator.

3. The laser system of claim 1, further comprising a driver circuit coupled to said laser diode.

4. The laser system of claim 1, wherein said optical fiber includes a proximal end and a distal end relative to said optical combiner, said grating having a varying spacing that decreases from said proximal end to said distal end.

5. A laser system, comprising:
a laser diode that emits a pulse of light having a first wavelength and a shorter second wavelength; and,
accumulator means for accumulating optical energy and spatially shifting the shorter second wavelength within the pulse to increase the power of the pulse.

6. The laser system of claim 5, wherein said accumulator means includes an optical fiber that includes a grating and a length between 0.1 and 2 kilometers to accumulate optical energy, and an optical combiner that is coupled to said laser diode and said chirped grating.

7. The laser system of claim 6, wherein said optical combiner includes an optical circulator.

8. The laser system of claim 5, further comprising a driver circuit that provides an electrical pulse to said laser diode.

9. The laser system of claim 6, wherein said optical fiber includes a proximal end and a distal end relative to said optical combiner, said grating having a varying spacing that decreases from said proximal end to said distal end.

10. A method for generating a laser pulse, comprising:
generating a laser pulse from a laser diode, the laser pulse having a first wavelength and a shorter second wavelength; and,
storing optical energy within an optical fiber that has a length between 0.1 and 2 kilometers, and spatially shifting the second wavelength within the pulse to increase the power of the pulse.

11. The method of claim 10, wherein the second wavelength is shifted toward the first wavelength.

12. The method of claim 10, wherein the second wavelength is shifted by a grating of the optical fiber, and combined with the first wavelength within an optical combiner.
